(19) United States
(12) Patent Application Publication
(10) Pub. No.: US 2019/0098868 A1
(43) Pub. Date: Apr. 4, 2019

(54) CONTAMINATION INHIBITING LIVESTOCK WATER BOWL

(71) Applicant: Andrew Kenny, Beachbury (CA)

(72) Inventor: Andrew Kenny, Beachbury (CA)

(21) Appl. No.: 15/724,975

(22) Filed: Oct. 4, 2017

(51) Int. Cl. A01K 7/06; B08B 9/093

(52) U.S. Cl. CPC A01K 7/06; B08B 9/093

(57) ABSTRACT

A water bowl for providing water to livestock animals to drink from. The bowl allows itself to be pivoted to a tipped position to allow for removal of debris or dirty water from inside surfaces of the bowl by an internally positioned water valve, and thus improve the quality of water for livestock. The bowl also minimizes the surface area of water in the bowl that is open to contamination.

### FIELD OF THE INVENTION

The invention relates to a water bowl for providing water to livestock that allows for the water bowl itself to be pivoted to a fully tipped position to allow for removal of debris or dirty water from the bowl by an internally positioned water valve that can also rinse off inside surfaces of the bowl, and thus improve the quality of water for livestock, while, at the same time, minimizing the volume of water in the water bowl that is potentially open to contamination.

### BACKGROUND OF THE INVENTION

Livestock farming, and in particular dairy farming, represents a way of life for many farmers around the world. In order to provide large volumes of quality milk it is commonly accepted practice to provide as much drinking water as the animals choose to drink.

A typical design for a water bowl used in dairy farming comprises a bowl for holding water, a water supply line and a valve. The valve supplies water from the water supply line to the bowl in response to a movement of the valve. Common designs for valves provide water when the valve is nudged by the muzzle of the cow. Thus, the cow is able to activate the valve and thereby provide water to the bowl as desired by the cow. Such a design is provided by Li et al, in U.S. Pat. No. 6,332,428. Typically, when the cow is drinking water from the bowl, the valve is not engaged and water flow stops. This problem has been addressed by others as well. For example, Anderson describes an alternative water bowl for cattle in U.S. Pat. No. 2,260,817. One problem that conventional water bowl containers, such as troughs, have is that since these troughs contain a large volume of water, the risk of contamination of drinking water is increased, especially if water is stagnant or contains debris for a period of time, which is a persistent, ongoing issue for farmers. In fact, it is not uncommon for such troughs to contain approximately 2700 litres, or more, of water therein, the sheer size of which mitigates against regular flushing of water to achieve a truly “clean” environment.

One further issue is that, in a free stall environment, livestock (cows) are not tied, and, in this environment, they generally walk into a stall when they want to lie down, travel to a feed manger when they want to eat, and travel to a separate water station or water trough when they are thirsty. The main problem with such water troughs in a free stall environment is that livestock (cows) are potentially able to defecate in these bowls, due to the fact that these troughs are positioned lower to the floor surface, and then the farmer is required to clean the bowl.

It would be beneficial to provide a smaller profile water bowl that livestock, and particularly dairy cows, are able to drink freely from, while minimizing the volume of water in this smaller profile water bowl that is potentially open to contamination.

Further, it would be advantageous to provide such a water bowl with the ability to pivot to a fully tipped position, whereby the bowl, and inside surfaces thereof, can be completely cleaned and rinsed easily by an internally positioned water valve, to further reduce the risk of water contamination, and to improve water quality for the livestock. To this end, the present invention effectively addresses these needs.

### SUMMARY OF THE INVENTION

The present invention provides the advantage of an improved water bowl that livestock, and particularly dairy cows, are able to drink freely from that minimizes the surface area of water in the water bowl that is open to potential contamination.

The present invention also provides the advantage of an improved water bowl with the ability to pivot to a fully tipped position, whereby the inside surfaces of the water bowl can be cleaned and rinsed of dirt and debris easily by an internally positioned water valve, to further reduce the risk of water contamination, and to improve water quality for the livestock.

According to a first broad aspect of the present invention, there is disclosed an apparatus for providing water to a livestock animal, comprising a vessel for retaining water; a valve biased to a closed position for substantially preventing a flow of water into the vessel, the valve operable between the closed position and an open position for controllably dispensing the water into the vessel when contacted by the livestock animal; and whereby the vessel is pivotable from a drinking position to a tipped position to allow for removal of debris or dirty water from inside surfaces of the vessel by the valve.

According to another broad aspect of the present invention, there is disclosed an apparatus for providing water to a livestock animal, comprising a vessel for retaining water, the vessel containing less than 0.5 square feet of the water in the vessel open for potential contamination, wherein the vessel is positioned proximate a height of a muzzle of the livestock animal; a valve biased to a closed position for substantially preventing a flow of the water into the vessel, the valve being operable between the closed position and an open position for controllably dispensing the water into the vessel when contacted by the livestock animal, the valve being movable in a range of about 10 to 15 degrees from its vertical axis; and whereby the vessel is pivotable from a drinking position to a tipped position to allow for removal of debris or dirty water from inside surfaces of the vessel by the valve.

According to another broad aspect of the present invention, there is disclosed a method of manufacturing an apparatus for a method of manufacturing an apparatus for providing water to a livestock animal comprising providing a vessel for retaining water; providing a valve biased to a closed position for substantially preventing a flow of water into the vessel, the valve being operable between the closed position and an open position for controllably dispensing the water into the vessel when contacted by a livestock animal; and providing the vessel to be pivotable from a drinking position to a tipped position to allow for removal of debris or dirty water from inside surfaces of the vessel by the valve.

### BRIEF DESCRIPTION OF THE DRAWINGS

The embodiments of the present invention will now be described by reference to the following figures, in which identical reference numerals in different figures indicate identical elements and in which:

FIG. 1A is a side view of a prior art water trough for livestock;

FIG. 1B is a side view of a water bowl for livestock according to an embodiment of the present invention;

FIG. 2A is a top view of the prior art water trough for livestock shown in FIG. 1A;

FIG. 2B is a top view of the embodiment of the water bowl of the present invention shown in FIG. 1B;

FIG. 3 is a side view of the embodiment of the water bowl of the present invention shown in FIGS. 1B and 2B, illustrating the bowl in a drinking position; and

FIG. 4 is a side view of the embodiment of the water bowl of the present invention shown in FIGS. 1B and 2B, illustrating the bowl in a fully tipped position.

### DETAILED DESCRIPTION OF THE INVENTION

The invention will be described for the purposes of illustration only in connection with certain embodiments. However, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

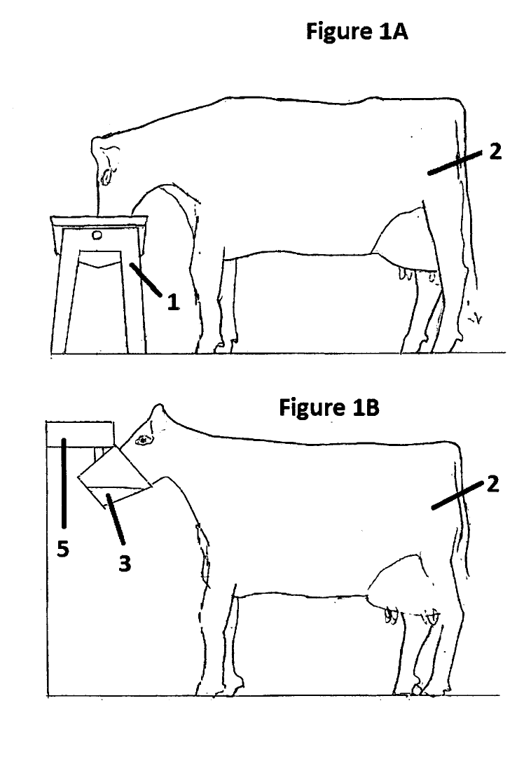

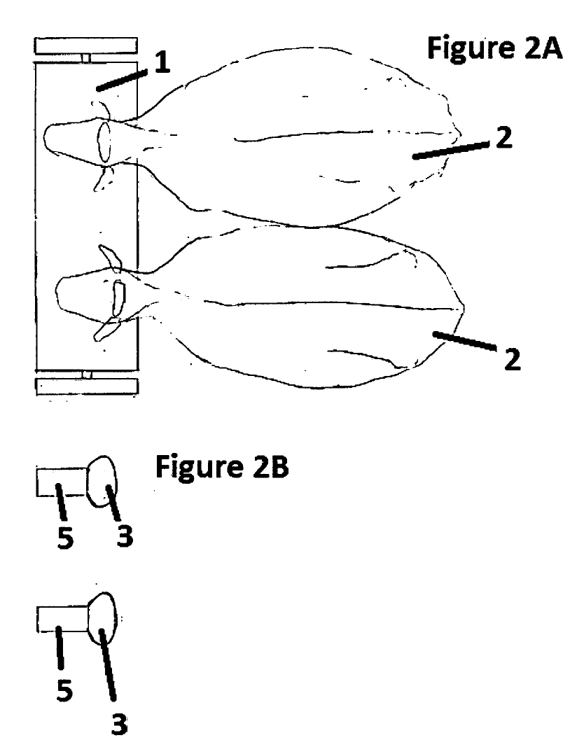

Referring to FIGS. 1A and 2A, there is shown a conventional prior art water trough 1 for cattle 2 (contrasted to the present invention 3 as shown in FIGS. 1B and 2B). These typically contain large volumes of water, and it is not uncommon for such troughs to contain approximately 2700 litres, or more, of water therein. As such, cleaning these troughs typically means large quantities of water must be dumped, and can mean extra expenses for a farmer in having to refill these troughs over the course of a year, as ample water storage ability on site is generally required to do so.

Moreover, the number of livestock or cattle that can be accommodated at such troughs at any one time can be limited.

With reference to FIGS. 1B and 2B, it can be seen that the water bowl 3 of the present invention for livestock or cattle 2 possesses, in an exemplary embodiment, a frame portion 5 which is mounted to a wall or a post (not shown in these Figures) in a free stall environment, the bowl 3 being pivotably hinged to the frame portion 5. In a further exemplary embodiment, the bowl 3 is mounted to the wall or the post in the free stall environment at a height which is proximate to a height of the muzzle of the livestock animal 2. This is in stark contrast to the prior art water trough, seen in FIGS. 1A and 2A, wherein the livestock animal must lower its head to drink from the trough, as the trough is generally positioned nearer to the barn stall floor. As such, there is a greater potential risk of the livestock animal ultimately defecating in its own water supply, thus requiring the farmer to clean the entire trough, or, at the very least, monitoring the situation frequently to defend against this scenario from happening, resulting in aggravating time expenditures for the farmer.

Moreover, as was previously noted, conventional water troughs can be limited in terms of accommodating cattle or livestock at any one time, due to their generally linear and elongated placement. By contrast, as seen in FIG. 2B, the water bowl of the present invention, due to its smaller profile, is much more flexible in maximizing floor space in a free stall environment, in terms of where these units can be positioned and utilized, regardless of barn stall layouts or floor plans.

As noted previously, one important advantage of the present invention is to provide a water bowl with the ability to pivot from a drinking position to a fully tipped position, whereby the inside surfaces of the water bowl can be cleaned and rinsed of dirt and debris easily by an internally positioned water valve, to further reduce the risk of water contamination, and to improve water quality for the livestock.

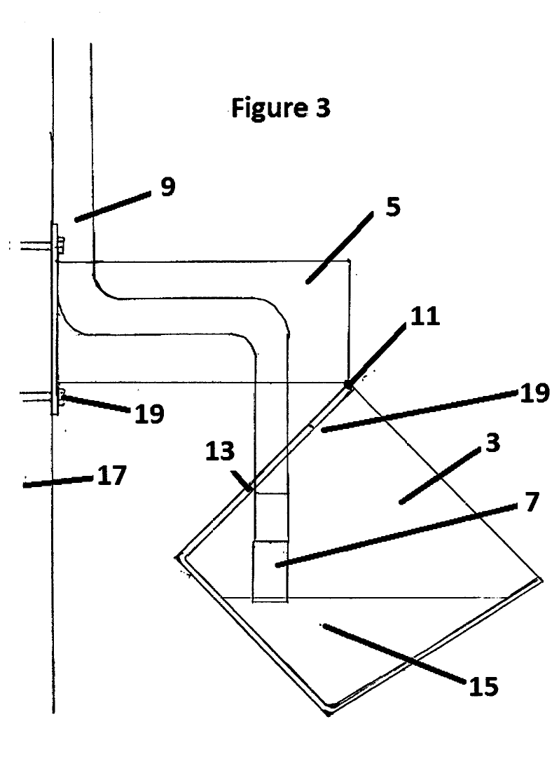

With reference to FIG. 3, which illustrates the water bowl 3 in a drinking position for livestock, it can be seen that bowl 3 further includes a valve 7 designed to provide water, via a water supply line 9, in response to a movement of the valve 7 associated with a livestock animal (not shown) pushing or contacting the valve 7 with its muzzle. When a livestock animal (ie: a cow) actuates the valve 7 water is provided to the bowl 3. In an exemplary embodiment, the valve 7 is rotatable, and can be actuated when pushed or contacted in any direction. In an exemplary embodiment, this movement of the valve is between 10-15 degrees from its vertical axis. In a further exemplary embodiment, the water bowl 3 of the present invention holds about a maximum of 2 litres of water therein (though of course variations to this amount would be understood by one skilled in the art), which allows for much less water waste when the bowl is eventually tipped or dumped for cleaning, in contrast to the much larger amounts of water required to be dumped for cleaning purposes from conventional water troughs as shown in FIGS. 1A and 2A.

With reference again to FIG. 3, a frame portion 5 is mounted to a wall or a post 17 in a free stall environment by bolts 19 or other means, and the bowl 3 is pivotably hinged to the frame portion 5 at hinge point 11, preferably by a hinge pin, though it will be understood that variations to this pivotable connection are possible. It will also be understood that pivotable connection of the bowl 3 can be accomplished by connection of the bowl 3 to the frame portion 5, or through connection of the bowl 3 to a side portion of wall or post 17 in a free stall environment (thus dispensing with the frame portion 5 entirely), or variations thereof. Further, one example of a water level 15 in the bowl 3, in the drinking position, is also illustrated in FIG. 3.

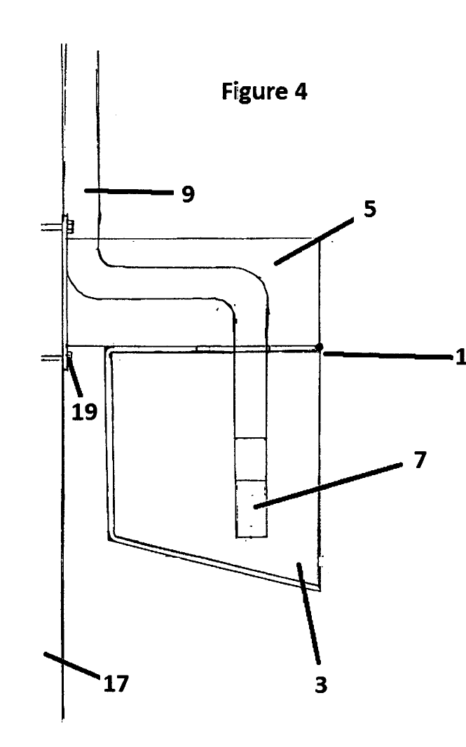

Moreover, the bowl 3 further comprises an elongated slot defined in a rear portion thereof (this slot being shown as extending from 13,19 in FIG. 3), to accommodate the valve 7 when the bowl 3 is moved from the drinking position to the fully tipped position shown in FIG. 4, because the valve 7 is meant to stay stationary when such movement of the bowl 3 occurs (the valve 7 moving within the parameters of elongated slot 13, 19 as the bowl 3 moves from the drinking position to the fully tipped position), and does not tip with the bowl 3, though it will be appreciated that deviations from this are possible.

FIG. 4 illustrates the bowl 3 pivoting to a fully tipped position, whereby the inside surfaces of the water bowl 3 can be cleaned and rinsed easily by the water valve 7, to further reduce the risk of water contamination, and to improve water quality for the livestock. Of course, the hinge point 11 will allow the bowl 3 to be pushed back to tip the water contents out onto the floor. If the bowl 3 requires flushing, the farmer can manually push the bowl 3 back into the fully tipped position. The bowl 3 can be held at any point between the drinking and fully tipped positions so that the valve 7 can be aimed to spray water at a dirty spot on the interior of bowl 3. This allows a high pressure spray of water to be directed onto the inside surfaces of the bowl 3 to spray debris off the inside surfaces of the bowl 3.

In an exemplary embodiment, water bowl 3 is operably able to pivot from a drinking position 60 degrees from its vertical axis to a fully tipped position, though of course, it will be understood that variations to this angle are possible. It will also be understood that the bowl 3 when in a drinking position and pivotably hanging from frame portion 5, hangs at about a 45 degree angle from its vertical axis.

In an exemplary embodiment, the bowl 3 will be operably able to be tipped downwardly, whereby tipping of the bowl 3 is what allows the water valve 7 to be directed onto a much larger portion of the insides surfaces of the bowl 3 so that it can be cleaned fully.

It will also be understood that the ability of the water bowl 3 to pivot, allows the bowl to tip and empty when livestock naturally bump into it or move past in a free stall environment, whereby stale or dirty water can be emptied so that fresh water can replace it. Livestock often push or bunt items in their environment, and it is a natural behaviour that can be taken advantage of to save work for the farmer. If the bowl 3 gets dirty or full of debris, livestock may inadvertently bunt or push the bowl 3 enough for the bowl 3 to tip and flush itself clean. In this scenario, no labour is required to accomplish this.

With respect to the issue of water contamination, for example, a standard 8 foot×2 foot trough (which can be used in accordance with prior art trough shown in FIGS. 1A and 1B, may have 16 square feet open and available to potential contamination or debris. The water bowl 3 of the present invention, however, has, in an exemplary embodiment, less than 0.5 square feet of water in the bowl 3 open for potential contamination.

A person of skill in the art will appreciate that a water bowl designed in accordance with the embodiments of the invention provides a variety of benefits to farmers. For example, the bowl itself is not complex and consequently, it may be produced inexpensively without sacrificing quality or functionality.

It will be apparent to those skilled in this art that various modifications and variations may be made to the embodiments disclosed herein. Other embodiments consistent with the present invention will become apparent from consideration of the specification and the practice of the invention disclosed therein.

Accordingly, the specification and the embodiments are to be considered exemplary only, with a true scope of the invention being disclosed by the following claims.

I claim:

1. An apparatus for providing water to a livestock animal, comprising:
a vessel for retaining water;
a valve biased to a closed position for substantially preventing a flow of the water into the vessel, the valve being operable between the closed position and an open position for controllably dispensing the water into the vessel when contacted by the livestock animal; and
whereby the vessel is pivotable from a drinking position to a tipped position to allow for removal of debris or dirty water from inside surfaces of the vessel by the valve.

2. The apparatus of claim 1, wherein the vessel is pivotable downwardly.

3. The apparatus of claim 1, wherein the vessel is operably able to pivot from the drinking position to about 60 degrees to assume the tipped position.

4. The apparatus of claim 1, wherein the valve is rotatable, and can be actuated to the open position when pushed or contacted in any direction by the livestock animal.

5. The apparatus of claim 4, wherein the valve is movable in a range of about 10 to 15 degrees from its vertical axis.

6. The apparatus of claim 1, wherein the vessel further comprises a frame portion joined to a structural member integrated within a stall environment, and a bucket portion pivotably connected to the frame portion.

7. The apparatus of claim 1, wherein the frame portion is pivotably connected to the bucket portion by a hinge pin.

8. The apparatus of claim 1, wherein the vessel is pivotably joined to a side portion of a structural member integrated within a stall environment.

9. The apparatus of claim 1, wherein the vessel contains less than 0.5 square feet of water in the vessel open for potential contamination.

10. The apparatus of claim 8, wherein the vessel is mounted to the structural member proximate a height of a muzzle of the livestock animal.

11. The apparatus of claim 1, wherein the vessel holds about a maximum of 2 litres of water therein.

12. The apparatus of claim 1, wherein, when the vessel is in a drinking position, the vessel hangs at about 45 degrees from its vertical axis.

13. The apparatus of claim 1, wherein the vessel further comprises an elongated slot defined in a rear portion thereof, to accommodate the valve when the vessel is moved from the drinking position to the tipped position.

14. An apparatus for providing water to a livestock animal, comprising:
a vessel for retaining water, the vessel containing less than 0.5 square feet of the water in the vessel open for potential contamination, wherein the vessel is positioned proximate a height of a muzzle of the livestock animal;
a valve biased to a closed position for substantially preventing a flow of the water into the vessel, the valve being operable between the closed position and an open position for controllably dispensing the water into the vessel when contacted by the livestock animal, the valve being movable in a range of about 10 to 15 degrees from its vertical axis; and
whereby the vessel is pivotable from a drinking position to a tipped position to allow for removal of debris or dirty water from inside surfaces of the vessel by the valve.

15. The apparatus of claim 14, wherein the vessel is operably able to pivot from the drinking position to about 60 degrees to assume the tipped position.

16. A method of manufacturing an apparatus for a method of manufacturing an apparatus for providing water to a livestock animal comprising:
providing a vessel for retaining water;
providing a valve biased to a closed position for substantially preventing a flow of water into the vessel, the valve being operable between the closed position and an open position for controllably dispensing the water into the vessel when contacted by a livestock animal; and
providing the vessel to be pivotable from a drinking position to a tipped position to allow for removal of debris or dirty water from inside surfaces of the vessel by the valve.

17. The method of claim 16, further comprising the step of providing the vessel to be operably able to pivot from the drinking position to about 60 degrees to assume the tipped position.

18. The method of claim 16, further comprising the step of providing the valve to be operably movable in a range of about 10 to 15 degrees from its vertical axis.

19. The method of claim 16, further comprising the step of manufacturing the vessel to contain less than 0.5 square feet of the water in the vessel open for potential contamination.

20. The method of claim 16, further comprising the step of providing the vessel with a frame portion operable to be connected to a structural member integrated within a stall environment, and a bucket portion pivotably connected to the frame portion.
